(19) United States
(12) Patent Application Publication
(10) Pub. No.: US 2021/0163319 A1
(43) Pub. Date: Jun. 3, 2021

(54) WATER TREATMENT APPARATUS AND WATER TREATMENT METHOD USING SAME

(71) Applicant: IUCF-HYU (Industry-University Cooperation Foundation Hanyang University), Seoul (KR)

(72) Inventors: Rhokyun KWAK, Seoul (KR); Inhee CHO, Seongnam-si (KR); Minchan KIM, Seoul (KR); Hahnsoll RHEE, Seongnam-si (KR); Junbeom LIM, Seoul (KR)

(21) Appl. No.: 17/111,145

(22) Filed: Dec. 3, 2020

(30) Foreign Application Priority Data
Dec. 3, 2019 (KR) 10-2019-0159226
Dec. 2, 2020 (KR) 10-2020-0166881

(51) Int. Cl. C02F 1/46

(52) U.S. Cl. CPC C02F 1/4604; C02F 2001/46123

(57) ABSTRACT

Disclosed are a water treatment apparatus including an anode, a cathode disposed to face the anode at a distance therefrom, and at least one electrochemical unit disposed at a distance from the anode and the cathode, respectively, wherein the electrochemical unit includes a layer having bipolarity when a voltage is applied between the anode and the cathode, and a water treatment method using the same.

### CROSS-REFERENCE TO RELATED APPLICATION

This application claims priority to and the benefit of Korean Patent Application Nos. 10-2019-0159226 and 10-2020-0166881 filed in the Korean Intellectual Property Office on Dec. 3, 2019, and Dec. 2, 2020, respectively, and all the benefits accruing therefrom under 35 U.S.C. § 119, the entire contents of which are incorporated herein by reference.

### BACKGROUND OF THE INVENTION

### (a) Field of the Invention

The present disclosure relates to a water treatment apparatus and a water treatment method using the same.

### (b) Description of the Related Art

Recently, water shortage is emerging as an important issue in the most countries around the world due to increased water consumption according to population growth and rapid industrialization and water pollution according to environmental pollution. In addition, the demand for water is expected to continuously increase due to increased economic scale and industrial development in the future, and accordingly, stable and innovative water resources need to be secured more urgently than ever for a future water shortage.

The countries highly possibly facing the future water shortage, including Korea, are in a desperate need for technical preparation, and especially, desalination technology is almost the only means to cope with the water shortage by desalinating sea water and salty water that indefinitely exist on the planet with no influence from drought. However, among the desalination technologies, evaporation and reverse osmosis desalination technologies, which currently dominate the market, pose a sustainability problem due to high consumption of fossil fuels and a high cost required for constructing a plant. In addition, a membrane-based desalination technology, like the reverse osmosis desalination technology, is a technology of changing salt concentrations in sea water at both end of a membrane by controlling the flow of water or ions and thus simultaneously produces fresh water with a lower ion concentration and concentrated water with a higher ion concentration. However, when the concentrated water produced through the desalination process is discharged into the sea, there may be a problem of destroying ecosystems by causing eutrophication or reducing the amount of dissolved oxygen in seawater, and when landfilled inland, there also may be a problem of contaminating groundwater.

### SUMMARY OF THE INVENTION

An embodiment provides a water treatment apparatus having improved ion removal efficiency and no discharge of concentrated water.

Another embodiment provides a water treatment method using the water treatment apparatus.

According to an embodiment, a water treatment apparatus includes an anode, a cathode disposed to face the anode at a distance from the anode, and at least one electrochemical unit disposed at a distance from the anode and the cathode, respectively, wherein the electrochemical unit includes a layer having bipolarity when a voltage is applied between the anode and the cathode.

The layer having bipolarity may include an inorganic compound, an organic compound, a mixture of an inorganic compound and an organic compound, a composite of an inorganic compound and an organic compound, or a combination thereof.

The inorganic compound may contain a metal.

The metal may include a transition metal, a post-transition metal, a metalloid, or a combination thereof.

The organic compound may include carbon, a conductive polymer, or a combination thereof.

The at least one electrochemical unit may further include a cation exchange membrane and/or an anion exchange membrane respectively disposed on one surface or both surfaces of the layer having the bipolarity facing the anode and/or cathode.

The cation exchange membrane may be an organic material membrane including polystyrene, polyimide, polyester, polyether, polyethylene, polytetrafluoroethylene, polymethylammonium chloride, polyglycidyl methacrylate, or a combination thereof, a NASICON ceramic film, or a phosphoric acid-doped FBI film (PA doped polybenzimidazole membrane).

The layer having the bipolarity may be a plate type, a mesh type, a compressed type of particles, a solution type including particles, or a combination thereof.

The water treatment apparatus may include two or more electrochemical units between anode and the cathode, wherein the two or more electrochemical units are disposed to have a space therebetween.

The water treatment apparatus further includes a housing that accommodates the anode, the cathode, and the at least one electrochemical units therein, and further includes a water inlet for feeding water to a space between the anode and the at least one electrochemical unit and between the cathode and the at least one electrochemical unit, and a water outlet for discharging water discharged from the space.

According to another embodiment, a water treatment method includes while applying a voltage between an anode and a cathode disposed in a water treatment apparatus that further includes an electrochemical unit disposed between the anode and the cathode, the electrochemical unit including a layer having bipolarity when a voltage is applied between the anode and the cathode, feeding water including a salt to a space between the anode and the electrochemical unit and to a space between the cathode and the electrochemical unit, such that a cation and an anion are separated from the salt and move to the anode, cathode, and the layer having bipolarity in the electrochemical unit, and discharging desalted water.

At least one of both surfaces of the layer having bipolarity, and/or at least one of the surfaces facing the layer having bipolarity of the anode and the cathode may further include a cation exchange membrane or an anion exchange membrane disposed on the surface, or a combination thereof.

In the above method, the voltage applied between the anode and the cathode may be about 0.1 V to about 1,000 V.

The cation and anion moved to the anode, cathode, and the layer having bipolarity of the electrochemical unit may be adsorbed to at least one of the anode, the cathode, and/or the layer having bipolarity of the electrochemical unit.

The cation and anion moved to the anode, cathode, and the layer having bipolarity of the electrochemical unit may perform an irreversible electrochemical reaction with at least one of the anode, the cathode, and/or the layer having bipolarity of the electrochemical unit.

The water treatment method does not produce brine.

In the above method, the layer having bipolarity may include a solution including particles or may be a mesh type.

In the above method, the solution including particles may be a solution including zinc particles.

According to another embodiment, a water treatment method includes while applying a voltage between an anode and a cathode disposed to face the anode and have a space therefrom, feeding water including a salt to the space, such that a cation and an anion are separated from the salt in the water and move to the anode and cathode, respectively, wherein the moved cation and/or anion performs an irreversible electrochemical reaction with the anode and/or cathode, respectively, and discharging desalted water.

In the water treatment method, an anion exchange membrane may be disposed on one surface of the cathode, and a cation exchange membrane may be disposed on one surface of the anode.

By using the water treatment apparatus and method according to the present invention, unlike conventional water treatment apparatuses and methods, concentrated water including concentrated salt, i.e., brine, is not produced, and a salt separated may be converted into a high value-added inorganic metal compound. Accordingly, the water treatment apparatus and the water treatment method according to the present invention can not only reduce environmental pollution by solving a problem of concentrated water generated during water treatment, but also provide an additional economic advantage.

### BRIEF DESCRIPTION OF THE DRAWINGS

FIG. 1 is a schematic cross-sectional view of a water treatment apparatus according to an embodiment.

FIG. 2 is a schematic cross-sectional view of a water treatment apparatus according to another embodiment.

FIG. 3 is a schematic cross-sectional view of a water treatment apparatus for explaining a water treatment method according to another embodiment.

FIG. 4 is a real-time fluorescence brightness analysis image showing the desalting process of the water treatment apparatus according to Preparation Example 2.

FIG. 5 is a graph showing a desalination performance of the water treatment apparatus according to Preparation Example 2 through real-time fluorescence brightness analysis of FIG. 4.

FIG. 6 is a graph showing the salt removal rate and energy consumption rate according to the salt concentration (salinity) of the water treatment apparatus according to Preparation Example 2.

FIG. 7 is a real-time fluorescence brightness analysis image showing the desalting process of the water treatment apparatus according to Preparation Example 3.

FIG. 8 is a graph showing the desalting performance of the water treatment apparatus according to Preparation Example 3 through real-time fluorescence brightness analysis of FIG. 7.

FIG. 9 is a view schematically illustrating a water treatment apparatus according to Preparation Example 4, a desalting process using the same, and a formation and discharge process of a new compound generated therefrom.

FIG. 10 is a view schematically illustrating a water treatment apparatus according to Preparation Example 5, a desalination process using the same, and a formation and discharge process of a new compound generated therefrom.

FIG. 11 is a schematic view illustrating a water treatment apparatus in which two or more electrochemical units included in the water treatment apparatus shown in FIGS. 9 and 10 are stacked, and an operation method thereof.

FIG. 12 is a schematic view showing a water treatment apparatus according to Experimental Example 4 and an operating principle thereof.

FIG. 13 is a photograph showing the result of observing the ion depletion layer around the membrane-carbon assembly of the water treatment apparatus shown in FIG. 12 through an upright microscope (Axio Zoom V16, Zeiss) and an EMCCD camera (Axiocam 506 ccolor, Zeiss).

FIG. 14 is a current-voltage graph showing that the driving voltage is lowered when the same amount of ion flow (current) is generated compared with the existing system in the desalting process using the water treatment apparatus shown in FIG. 12.

FIG. 15 is a schematic view showing a water treatment apparatus according to Preparation Example 6 and an operating principle thereof.

FIG. 16 is an electron microscope photograph showing that in the water treatment apparatus according to Preparation Example 6, a new compound generated by reacting a cathode with cations introduced through a cation exchange membrane is not dissolved in an organic solvent and is present in a solid state in a channel formed between the cation exchange membrane and the cathode.

FIG. 17 is a schematic view showing the water treatment apparatus according to Preparation Example 7 and an operating principle thereof.

### DETAILED DESCRIPTION OF THE EMBODIMENTS

Advantages and characteristics of this disclosure, and a method for achieving the same, will become evident referring to the following example embodiments together with the drawings attached hereto. However, the present invention is not limited to the embodiments disclosed below, but will be implemented in various forms different from each other. Only the present embodiments are provided to complete the disclosure of the present invention, and to fully inform the scope of the invention to those skilled in the art to which the present invention pertains, and the invention is only defined by the scope of the claims. Thus, in some embodiments, well-known techniques have not been described in detail in order to avoid obscuring interpretation of the present invention. Unless otherwise defined, all terms (including technical and scientific terms) used in the present specification may be used as meanings that can be commonly understood by those of ordinary skill in the art to which the present invention belongs. In addition, terms defined in a commonly used dictionary are not interpreted ideally or excessively unless explicitly defined specifically. In addition, unless explicitly described to the contrary, the word “comprise”, and variations such as “comprises” or “comprising”, will be understood to imply the inclusion of stated elements but not the exclusion of any other elements.

In order to clearly describe the present invention, parts irrelevant to the description are omitted, and the same reference numerals are assigned to the same or similar components throughout the specification.

In addition, the size and thickness of each component shown in the drawings are arbitrarily shown for convenience of description, and are not necessarily limited to those shown in the present invention.

It will be understood that when an element such as a layer, film, region, or substrate is referred to as being “on” another element, it may be directly on the other element or intervening elements may also be present. In contrast, when an element is referred to as being “directly on” another element, there are no intervening elements present.

Embodiments described in the present specification will be described with reference a schematic views that are ideal exemplary views of the present invention. Accordingly, the regions illustrated in the drawings have schematic properties and are not intended to limit the scope of the invention.

Hereinafter, referring to the drawings, a water treatment apparatus, and a water treatment method using the same are described.

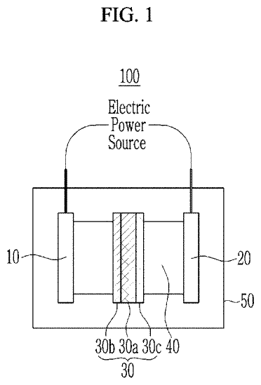

FIG. 1 is a cross-sectional view schematically showing the structure of a water treatment apparatus 100 according to an embodiment.

Referring to FIG. 1, a water treatment apparatus 100 according to an embodiment includes an cathode 20, a anode 10 disposed to face each other at a distance from the cathode 20, and an electrochemical unit 30 disposed at a distance from the cathode 20 and the anode 10.

The cathode 20 and the anode 10 are electrically connected to each other, and at least one of the cathode 20 and the anode 10 may be connected to an external power source to apply a voltage to the water treatment apparatus 100. The cathode 20 or the anode 10 may include graphite, activated carbon, graphene, carbon nanotubes, carbon (nano) fibers, carbon spheres, or a combination thereof, but is not limited thereto, and may include any electrode-forming material that is not corroded or structurally unstable in contact with water and is known to be suitable for use in water treatment apparatuses in the art. For example, the cathode 20 or the anode 10 may be a graphite plate or graphite foil, or may include at least one metal selected from Cu, Al, Ni, Fe, Co, and Ti, a metal mixture, or an alloy. In addition, various types of conductors may be used as the cathode 20 or the anode 10.

A shape of the cathode 20 or the anode 10 is not particularly limited, and may be, for example, in the form of a thin film or plate, and may include a foam structure, a mesh structure, etc.

A thickness of the cathode 20 or the anode 10 is not particularly limited and may be appropriately selected. For example, the thickness of the cathode 20 or anode 10 may be in a range of about 50 μm to about 500 μm, for example, about 100 μm to about 500 μm, for example, about 100 μm to about 400 μm, for example, about 100 μm to about 350 μm, for example, about 100 μm to about 300 μm, for example, about 150 μm to about 300 μm.

The electrochemical unit 30 includes a layer 30a having bipolarity (hereinafter also referred to as “bipolar layer”) when a voltage is applied between the cathode 20 and the anode 10.

When a voltage is applied through the cathode 20 and the anode 10 of the water treatment apparatus 100, the layer 30a having bipolarity includes a material having bipolarity through dielectric polarization in which negative and positive charges in the layer 30a are polarized toward the surfaces facing the cathode 20 and the anode 10, respectively. Therefore, when a voltage is applied through the cathode 20 and the anode 10, the surface of the bipolar layer 30a facing the cathode 20 is charged with negatives charge, and the surface facing the anode 10 is charged with positive charges. Accordingly, when passing seawater including salts, etc. between the cathode 20 and the electrochemical unit 30, and between the anode 10 and the electrochemical unit 30 while applying a voltage to the water treatment apparatus 100, under a potential gradient, salts included in the seawater, etc., are dissociated into cations and anions, the cations move toward a surface charged with negative charges of the bipolar layer 30a of the electrochemical unit 30, and the anions move toward the cathode 20, from seawater passing between the cathode 20 and the electrochemical unit 30; and the anions move toward the anode 10, and the anions move toward a surface charged with positive charges of the bipolar layer 30a of the electrochemical unit 30 from seawater passing between the anode 10 and the electrochemical unit 30.

Herein, in order for the cations and anions to move well to the surface charged with negative charges and the surface charged with positive charges of the bipolar layer 30a of the electrochemical unit 30, respectively, or to the corresponding surfaces of the bipolar layer 30a of the electrochemical unit 30, a cation exchange membrane 30b and an anion exchange membrane 30c may be formed on each of the corresponding surfaces of the bipolar layer 30a, respectively. Accordingly, the cations and anions separated from the water passing between the cathode 20 and/or anode 10 and the electrochemical unit 30 move to the surfaces charged with negative charges and positive charges of the bipolar layer 30a, through the anion exchange membrane 30c and cation exchange membrane 30b which are formed on both surfaces of the bipolar layer 30a of the electrochemical unit 30, respectively. In this way, the electrochemical unit 30 in the water treatment apparatus 100 according to an embodiment causes separations and movements of cations and anions from salts in water that require treatment, without applying a voltage by direct or indirect contact with an external power source. The moved cations and/or anions are adsorbed on the layer 30a having bipolarity in the electrochemical unit 30, or as will be described later, an irreversible oxidation or reduction reaction in the layer 30a having bipolarity may be caused to convert them to a new compound.

Meanwhile, the cation exchange membrane 30b and the anion exchange membrane 30c are arranged in contact with the surface of the bipolar layer 30a or spaced apart from the surface of the bipolar layer 30a. In the latter case, channels may be respectively formed between the bipolar layer 30a and the cation exchange membrane 30b and/or between the bipolar layer 30a and the anion exchange membrane 30c. In this case, a solution including particles of a material forming a bipolar layer, a non-aqueous organic solvent, an electrolyte, and the like, which will be described below may pass through the formed channels. In addition, in this case, as will be described below, a material that is formed by an irreversible electrochemical reaction of anions and/or cations introduced through the cation exchange membrane 30b and/or the anion exchange membrane 30c, with the bipolar layer 30a and/or particles of the material forming the bipolar layer, or an electrolyte or an inorganic compound introduced through the channels, may be easily discharged to the outside through these channels.

The cation exchange membrane 30b may be, for example, an organic film including polystyrene, polyimide, polyester, polyether, polyethylene, polytetrafluoroethylene, polymethyl ammonium chloride, polyglycidyl methacrylate, or a combination thereof, but is not limited thereto.

Alternatively, the cation exchange membrane 30b may be a ceramic membrane that does not pass water, for example, an oxide-type membrane including sodium, zirconium, silicon, phosphorus, and the like that allows only sodium ions to pass between water including ions and the layer 30a having bipolarity in the electrochemical unit 30, that is, a so-called NASICON ceramic film (Na₁₊ₓZr₂SiₓP₃₋ₓO₁₂, x=2). Since the NASICON ceramic membrane does not pass water, as will be described below, it may stably maintain a material with high reactivity with water among the products that can be produced by causing an irreversible electrochemical reaction of cations that are introduced by passing through the membrane, with the layer 30a having the bipolarity. The product stably maintained as described above may be separated and converted to a new compound having high added value, with or without a post-treatment process. For example, when the product is sodium hydride (NaH) produced by a chemical reaction of sodium (Na⁺) ions and hydrogen ions separated from water, trimethylborate is injected into a non-aqueous electrolyte through a channel formed between the bipolar layer 30a and the cation exchange membrane, and a hot wire is inserted between the cation exchange membrane and the bipolar layer of the electrochemical unit, and thereby the generated NaH may be converted to sodium borohydride (NaBH₄) simultaneously with synthesis. This sodium borohydride is a high value-added compound with many industrial uses. Therefore, the water treatment method according to an embodiment is a new method capable of producing a high value-added compound without generating concentrated water, unlike a conventional water treatment method for generating concentrated water as a by-product.

Meanwhile, in addition to the NASICON ceramic membrane, a polybenzimidazole (FBI) membrane doped with phosphoric acid as the cation exchange membrane 30b that does not pass water may be used, and the cation exchange membrane is not limited thereto.

The cation exchange membrane 30b may be a combination of the organic and inorganic membranes, or an organic-inorganic hybrid membrane.

The anion exchange membrane 30c may include, for example, polysulfone (PSF), polyether sulfone (PES), or a combination thereof, but is not limited thereto.

The layer 30a having the bipolarity may include an inorganic compound, an organic compound, a mixture of an inorganic compound and an organic compound, a composite of an inorganic compound and an organic compound, or a combination thereof.

The inorganic compound may include a metal, a non-metal, or a combination thereof.

The metal may be a transition metal, a post-transition metal, a metalloid, or a combination thereof.

The transition metal may include scandium (Sr), titanium (Ti), vanadium (V), chromium (Cr), manganese (Mn), iron (Fe), cobalt (Co), nickel (Ni), copper (Cu), and zinc. (Zn), yttrium (Y), zirconium (Zr), molybdenum (Mo), ruthenium (Ru), rhodium (Rh), palladium (Pd), silver (Ag), cadmium (Cd), hafnium (Hf), tungsten (W), iridium (Ir), platinum (Pt), gold (Au), a combination thereof, or an alloy thereof.

The post-transition metal may include aluminum (Al), gallium (Ga), indium (In), tin (Sn), thallium (TI), lead (Pb), bismuth (Bi), a combination thereof, or alloy thereof, and for example, the post-transition metal may include aluminum (Al), or a mixture or alloy of metals including the same.

The metalloid may include silicon (Si), germanium (Ge), antimony (Sb), telelium (Te), or a combination thereof, but is not limited thereto.

The organic compound may include carbon, a conductive polymer, or a combination thereof, but is not limited thereto.

The carbon refers to a material whose main component is composed of carbon atoms, and may have a compound type combined with other elements in addition to carbon alone. For example, the carbon may be a carbon fiber, graphite, a carbon nanomaterial, or a combination thereof which is composed of carbon alone, and the carbon nanomaterial may include a carbon nanotube, graphene, carbon nanoplate, fullerene, etc., but is not limited thereto.

The conductive polymer may be, for example, one compound or a mixture of two or more selected from polypyrrole, polythiophene, polyaniline, polyacetylene, polyphenylene sulfide, polyphenylenevinylene, polyindole, polypyrene, polycarbazole, polyazulene, polyazepine, polyfluorene, polynaphthalene, poly3,4-ethylenedioxythiophene-polystyrenesulfonate (PEDOT-PSS), and polyethylenedioxythiophene, but is not limited thereto.

The layer 30a having a bipolarity may be a plate type or a mesh type of the inorganic compound or the organic compound, a type obtained by compressing a particle slurry of the inorganic compound or the organic compound, and a solution type including the particle slurry, or a combination thereof. For example, the layer 30a having bipolarity may include at least one metal plate, or may include a combination of two or more different metal plates. Alternatively, the layer 30a having bipolarity may be at least one metal mesh, or may include a combination of two or more different metal meshes. Alternatively, the layer 30a having bipolarity may include at least one plate including an inorganic compound plated with the metal, or at least one plate including a combination of two or more different inorganic compounds plated with the metal. Alternatively, the layer 30a having the bipolarity may include at least one metal plated on the surface of the inorganic compound in the form of a mesh. For example, the layer 30a having the bipolarity may include carbon fibers in a plate type or a mesh type. Alternatively, the layer 30a having the bipolarity may be a plate type or a mesh type obtained by compressing a slurry including a carbon nanomaterial. Alternatively, the layer 30a having the bipolarity may be a combination of a metal plate, metal particles forming the metal plate, or a solution including other metal particles. In this case, as described above, in FIG. 1, the layer 30a having the bipolarity and a cation exchange membrane 30b and an anion exchange membrane 30c formed thereon are shown to be in close contact with the surface of the layer 30a, respectively, but is not necessarily limited thereto. The cation exchange membrane 30b and the anion exchange membrane 30c may be spaced apart from both surfaces of the bipolar layer 30a at a predetermined distance. Thereby, in this case, a material for forming the bipolar layer, for example, when the bipolar material is a metal, a solution including the metal particles and/or other metal particles may pass through a channel formed between the bipolar layer 30a and the cation exchange membrane 30b and/or between the bipolar layer 30a and the anion exchange membrane 30c. In this case, as described in detail in the examples to be described below, when the metal particles and ions introduced into the bipolar layer 30a through the ion exchange membrane perform an irreversible electrochemical reaction to generate a new compound, and the produced new compound may easily be isolated through the channel. In addition, in this case, in a continuous water treatment process, when the layer 30a having bipolarity and the metal particles are the same materials, it is also possible to solve the problem that the layer 30a having bipolarity is depleted by a continuous irreversible reaction with ions separated from water. On the other hand, when the liquid introduced through the channel is an organic solvent, as the organic solvent is not mixed with water, a material generated by an irreversible electrochemical reaction between the separated ions and the bipolar layer 30a can easily be discharged to the outside in the organic solvent.

In an embodiment, the layer 30a having the bipolarity may include zinc, and in this case, the layer 30a having the bipolarity may be a solution type including zinc particles in a channel formed between the bipolar layer 30a and the cation exchange membrane 30b, together with a zinc plate. When the layer 30a having the bipolarity includes a solution including zinc particles, while operating the water treatment apparatus, a solution including zinc particles is continuously fed to the channels formed between the layer 30a having the bipolarity and the cation exchange membrane 30a, thereby solving the problems that the bipolar layer 30a are depleted, or a product produced by a chemical reaction between the bipolar layer 30a and ions, for example, chloride ions (Cl⁻), for example, ZnCl₂ is adhered to the surface of the bipolar layer 30a to slow the irreversible electrochemical reaction. In addition, it is also advantageous to recover the generated ZnCl₂ from the water treatment apparatus.

A thickness of the layer 30a having the bipolarity is not particularly limited and may be appropriately selected. For example, the thickness of the layer 30a having the bipolarity may be in a range of about 100 μm to about 1,000 μm, for example, about 150 μm to about 800 μm, for example, about 150 μm to about 700 μm, for example, about 200 μm to about 600 μm, for example, about 200 μm to about 500 μm, for example, about 250 μm to about 500 μm.

In an embodiment, when the layer 30a having the bipolarity of the electrochemical unit 30 in the water treatment apparatus according to the embodiment includes aluminum (Al), and a salt such as NaCl is present in water requiring treatment, a redox reactions of chlorine ions (Cl⁻) and sodium ions (Na⁺) may occur on both surfaces of the layer 30a having bipolarity.

Specifically, as described above, the surface facing the anode 10 in the layer 30a having bipolarity is charged with positive charges, and the surface facing the cathode 20 is charged with negative charges according to the application of voltage. Therefore, when Cl⁻ ions flow into the surface charged with positive charges, these may perform an oxidation reaction that loses electrons through a reaction with Al metal and water in the bipolar layer 30a and generates aluminum chloride hydroxide (Al₂Cl(OH)₅). When Na⁺ ions flow into the surface charged with negative charges of the bipolar layer 30a, these may perform a reduction reaction that receives electrons while reacting with Al metal and water in the bipolar layer 30a and converts to sodium aluminum hydride (NaAlH₄). As described above, in the water treatment apparatus 100 according to an embodiment, the cations and anions separated from the salt in water move to and adsorb to both surfaces of the layer 30a having the bipolarity in the electrochemical unit 30, respectively. As will be described below, depending on the voltage applied between the cathode 20 and the anode 10, each may be converted into a new type of compound through an electrochemical reaction on the surfaces. The produced compounds exist in or on the surface of the bipolar layer 30a, and/or in the channels formed between the bipolar layer 30a and the cation exchange membrane 30b and/or the bipolar layer 30a and the anion exchange membrane 30c, and since the reaction for producing these compounds is an irreversible reaction, the produced compounds are not converted back to the original ions or salts. Therefore, in the water treatment method using the water treatment apparatus 100 according to an embodiment, while removing the salt included in the water to be treated to discharge desalted water, the separated salt or Ions may not produce concentrated water (brine), unlike in the conventional desalination technology such as reverse osmosis or electrodialysis. Therefore, the water treatment method using the water treatment apparatus according to an embodiment has an effect of reducing additional costs for treatment of concentrated water and/or environmental pollution problems. Further, the produced compounds may be inorganic metal compounds having high economic value, and thus, the water treatment method according to an embodiment may improve water shortage by desalination of seawater, etc., and may provide the additional advantage of providing inorganic metal compound s having high economic value.

The water treatment apparatus 100 according to an embodiment may further includes a housing 50 that accommodates an cathode 20, a anode 10, and an electrochemical unit 30 disposed between the cathode 20 and the anode 10 therein. In the housing 50, a water inlet (not shown) for feeding water to be treated to the flow path 40, which is a space between the electrodes 10 and 20 and the electrochemical unit 30, and a water outlet (not shown) for discharging the treated water may be provided. For example, the water inlet and the water outlet may be disposed on opposite sides at both ends in a longitudinal direction parallel to the electrodes 10 and 20 and the electrochemical unit 30 of the water treatment apparatus according to an embodiment. In an embodiment, while applying a voltage to the water treatment apparatus 100, water requiring treatment, for example, water including a salt is injected through the water inlet, the salt included in the water is separated into cations and anions by an electric field, as water moves along the flow path 40, and the separated cations and anions may be removed by being adsorbed on the surfaces of anode 10 and cathode 20, respectively, and both surfaces of the bipolar layer 30a in the electrochemical unit 30, as described above. In another embodiment, cations and anions that move into the surface of the bipolar layer 30a of the electrochemical unit 30 react with the material forming the bipolar layer 30a and/or the material that exists in channels between the bipolar layer 30a and ion exchange membranes to produce a new compound by irreversible oxidation and reduction reactions represented by the above-described Reaction Schemes 1 and/or 2, respectively. The produced compound may be an inorganic metal compound, and these compounds may be discharged without forming concentrated water.

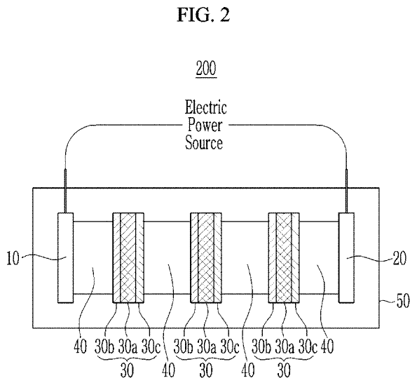

Meanwhile, in FIG. 1, although one electrochemical unit 30 exists between the cathode 20 and the anode 10, two or more electrochemical units may also be disposed between a pair of electrodes to configure the water treatment apparatus according to an embodiment. FIG. 2 is a schematic view of a water treatment apparatus including a plurality of electrochemical units arranged in parallel at a distance between a pair of electrodes.

Referring to FIG. 2, the water treatment apparatus 200 includes three electrochemical units 30 disposed in parallel at a distance between the cathode 20 and the anode 10. The three electrochemical units 30 are arranged in parallel with each other and parallel to the movement path of water to be treated. As shown in FIG. 2, when two or more electrochemical units are arranged and included in parallel, since the contact surface or contact space between the water to be treated and the electrochemical unit 30 increases in proportion to the number of the disposed electrochemical units, the water treatment amount and the treatment rate may increase in proportion to the number of the disposed electrochemical units. When two or more electrochemical units are connected in parallel, when a voltage is applied between the cathode 20 and the anode 10, by the electric field effect, all of the surfaces opposite to the cathode 20 among both surfaces of the bipolar layer 30a included in each electrochemical unit may be charged with negative charges and the other surfaces opposite to the anode 10 may all be charged with positive charges. Therefore, the salts in water passing through the flow path 40 between the electrochemical units 30 are separated into cations and anions, and while passing through the space, the cations and anions may move to each of the surface charged with negative charges and the surface charged with positive charges and then may be adsorbed.

As in FIG. 1, in the water passing through the flow path 40 between the cathode 20 and the electrochemical unit 30, or the flow path 40 between the anode 10 and the electrochemical unit 30, cations and anions separated from salts present in water may be separated by moving to a surface charged with a charge opposite to the corresponding positive and negative ions, respectively, among the surfaces of cathode 20 and anode 10, and the surface of the bipolar layer 30a of the electrochemical unit 30. As described above, in the water treatment apparatus 200 including two or more electrochemical units 30, since adsorption of ions separated from salts on the surfaces of cathode 20 and anode 10, or on each surface of bipolar layer or electrochemical unit 30, and/or irreversible electrochemical reaction may occur, the water treatment amount, and treatment speed and efficiency may be maximized.

In water treatment apparatus 100 or 200 according to an embodiment, at least one of cathode 20 or anode 10 is connected to an external power source to apply a voltage to the water treatment apparatus 100 or 200. At this time, the other electrode may be grounded.

A voltage applied between cathode 20 and anode 10 may be in a range of about 0.1 V to about 1,000 V, for example, about 1 V to about 1,000 V, for example, about 5 V to about 1,000 V, for example, about 10 V to about 1,000 V, for example, about 10 V to about 900 V, for example, about 10 V to about 800 V, for example, about 10 V to about 700 V, for example, about 10 V to about 600 V, for example, about 10 V to about 500 V for example, about 20 V to about 500 V, for example, about 30 V to about 500 V, for example, about 50 V to about 500 V, for example, about 100 V to about 500 V, for example, about 100 V to about 400 V, for example, about 100 V to about 300 V, for example, about 100 V to about 250 V, or for example, about 150 V to about 250 V.

When the applied voltage is less than about 0.1 V, a sufficient electric field for water treatment may not be formed. In other words, the separation of salts in water to be treated into ions, movement, adsorption, and removal of these ions to the oppositely charged anode or cathode, and/or the surface of the bipolar layer are not performed well, thereby significantly reducing water treatment efficiency.

Even when two or more electrochemical units 30 are included, the voltage applied between cathode 20 and anode 10 may be about 0.1 V to about 1,000 V, for example, about 1 V to about 1,000 V, for example, about 5 V to about 1,000 V, for example, about 10 V to about 1,000 V, for example, about 10 V to about 900 V, for example, about 10 V to about 800 V, for example, about 10 V to about 700 V, for example, about 10 V to about 600 V, for example, about 10 V to about 500 V for example, about 0 V to about 500 V, for example, about 30 V to about 500 V, for example, about 50 V to about 500 V, for example, about 100 V to about 500 V, for example, about 100 V to about 400 V, for example, about 100 V to about 300 V, for example, about 100 V to about 250 V, or for example, about 150 V to about 250 V, but is not limited thereto.

On the other hand, in the water treatment apparatus 100 or 200 according to an embodiment, when the separated cation and anion are subjected to an irreversible electrochemical reaction in the electrochemical unit 30a, a higher range of voltage may be required than in the case of simple adsorption of the cations and anions to the surface of the electrochemical unit.

Therefore, an irreversible electrochemical reaction is caused through the water treatment method according to an embodiment. Accordingly, in order not to generate concentrated water including separated ions or salts, a voltage of at least about 0.1 V or more may be applied. On the other hand, when the applied voltage exceeds 1,000 V, there may be problems of side reactions such as electrolysis of influent water at the cathode 20 or anode 10.

In the water treatment apparatus 100 or 200 according to an embodiment, when a voltage is applied between cathode 20 and anode 10, cations separated from salts in water and water molecules move in the electric field direction and reach the surface charged with negative charges of the bipolar layer 30a through the cation exchange membrane 30b of the electrochemical unit 30. Herein, the cation may be synthesized as a new compound, such as, for example, an inorganic metal compound, when the bipolar layer 30a is made of a metal, by a reduction reaction that receives electrons from the negative charge of the bipolar layer 30a. These inorganic metal compounds may be converted into various inorganic metal compounds depending on the type of metal that forms the bipolar layer 30a in the electrochemical unit 30 and/or the type of salt present in water. Accordingly, in order to obtain a desired inorganic metal compound using the water treatment apparatus and the water treatment method according to an embodiment, the type of metal forming the bipolar layer 30a, etc. may be selected. Therefore, the inorganic metal compound that can be synthesized by the reduction reaction as described above may be represented by Chemical Formula 1 or Chemical Formula 2, but is not limited thereto.

CₓM_{y}O_{z}(1≤x≤3,1≤y≤3,1≤z≤7) [Chemical Formula 1]

CₓM_{y}H_{z}(1≤x≤3,1≤y≤3,1≤z≤7) [Chemical Formula 2]

### In Chemical Formula 1 and Chemical Formula 2,

C is selected from Li, Na, K, Rb, Be, Mg, Ca, Sr, Ba, and a combination thereof,

M is selected from Ti, V, Cr, Mn, Fe, Co, Ni, Cu, Zr, Nb, Mo, Tc, Ru, Rh, Pd, Ag, Hf, Ta, W, Re, Os, Ir, Pt, Au, Al, Zn, Ga, Cd, In, Sn, Ti, Pb, Bi, Po, Si, Ge, As, Sb, Te, and a combination thereof, and

O is oxygen and H is hydrogen.

Meanwhile, in the water treatment apparatus 100 or 200 according to an embodiment, when a voltage is applied between cathode 20 and anode 10, anions separated from salts in water and water molecules move in the opposite direction of the electric field, and reach the surface charged with positive charges of the bipolar layer 30a through the anion exchange membrane 30c of the electrochemical unit 30. Herein, the anions may be synthesized as a new compound by an oxidation reaction that provides electrons to the positive charges of the bipolar layer 30a, for example, a second inorganic metal compound that is different from the inorganic metal compound produced by a reduction reaction between the cation and the bipolar layer 30a. It is the same that these inorganic metal compounds can also be converted into various inorganic metal compounds depending on the type of metal forming the bipolar layer 30a. For example, the inorganic metal compound that can be produced by the reduction reaction may be represented by Chemical Formula 3, but is not limited thereto:

AₓN_{y}O_{z}(1≤x≤3,1≤y≤3,1≤z≤7) [Chemical Formula 3]

### In Chemical Formula 3,

A is selected from Li, Na, K, Rb, Be, Mg, Ca, Sr, Ba, and a combination thereof,

M is selected from Ti, V, Cr, Mn, Fe, Co, Ni, Cu, Zr, Nb, Mo, Tc, Ru, Rh, Pd, Ag, Hf, Ta, W, Re, Os, Ir, Pt, Au, Al, Zn, Ga, Cd, In, Sn, Ti, Pb, Bi, Po, Si, Ge, As, Sb, Te, and a combination thereof, and

O means oxygen atom.

That is, the water treatment apparatus 100 or 200 according to the embodiment may synthesize inorganic metal compounds such as Al₂Cl(OH)₅ and NaAlH₄ through irreversible electrochemical reactions, for example, oxidation and/or reduction reactions on both surfaces of the electrochemical unit 30. Since these inorganic metal compounds are generated by being adsorbed on the inside the electrochemical unit or the surface of the bilayer layer, unlike conventional reverse osmosis or electrodialysis methods, salt or ion-concentrated water (brine) may not be generated. In addition, the generated compound may be an inorganic metal compound of high added value, such as Al₂Cl(OH)₅, NaAlH₄, and the like.

In the water treatment apparatus 200 including two or more electrochemical units 30 between the cathode 20 and the anode 10 as shown in FIG. 2, the cation exchange membrane 30b and the anion exchange membrane 30c disposed on both surfaces of the layer 30a having bipolarity, are not closely adhered to the surface of the layer 30a having bipolarity, and are to be spaced apart at a predetermined interval to form a channel, which is the same as in FIG. 1. It is also possible to feed a solution including particles of an organic solvent, a material forming the bipolar layer 30a, and/or other inorganic compounds through such a channel. In addition, since the configurations of the cathode 20, anode 10, bipolar layer 30, and the housing 50 including them are the same as those described with respect to FIG. 1, detailed descriptions thereof are omitted.

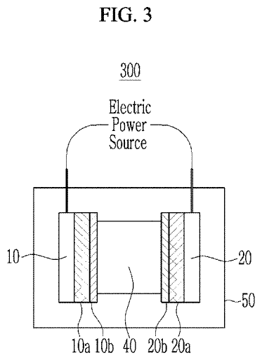

Meanwhile, in FIGS. 1 and 2, a water treatment apparatus including one or more electrochemical units 30 between a pair of electrodes and a water treatment method using the same have been described. Another embodiment of the present invention may use a water treatment apparatus 300 including a cathode 20, an anode 10 disposed to face the cathode 20 at a distance, and an anion exchange membrane 20b and the cation exchange membrane 10b on the cathode 20 and the anode 10, respectively, and a method for water treatment using the same principle (see FIG. 3).

Specifically, the water treatment method using the water treatment apparatus of FIG. 3 does not include electrochemical unit 30 between the pair of electrodes, compared with the water treatment apparatus of FIGS. 1 and 2, but instead the pair of electrodes itself plays the same role as the bipolar layer 30a of FIG. 1 when the voltage is applied. The cathode and anode are different in that the anion exchange membrane 10b and the cation exchange membrane 20b are respectively included, and the principle of operation thereof is substantially the same as the water treatment method described in FIGS. 1 and 2.

Specifically, referring to FIG. 3, while applying a voltage between the cathode 20 and anode 10, when water to be treated passes through the space between the cathode 20 and the anode 10, the salt included in the water is separated into cations and anions by the electric field, the separated cations move to the anode 10 through the cation exchange membrane 10b, and the separated anions move to the cathode 20 through the cation exchange membrane 20b.

Herein, there is no close contact between the cation exchange membrane 10b and the anode 10, and between the anion exchange membrane 20b and the cathode 20, and may be spaced apart at predetermined intervals to form channels 10a and 20a. In this case, the moved anions and cations are adsorbed on the surfaces of the cathode 20 and anode 10, respectively, or after being adsorbed, the anions and cations may perform irreversible electrochemical reactions with the cathode or anode, or with the materials present in the channels 10a and 20a, and as a result, the resulting materials may be present in the channels 10a and 20a or may be discharged to the outside through this channels. In addition, water passing through the space 40 between the cathode 20 and anode 10 may be desalted and discharged, and concentrated water including ions or salts may not be generated in this method.

The cathode 20, the anode 10, the anion exchange membrane 20b, and the cation exchange membrane 10b of the water treatment apparatus according to the aforementioned embodiment are as described in the aforementioned embodiment. As described above, a slurry of a material forming an cathode or an anode may be supplemented through the channels 10a and 20a formed between the cation exchange membrane 10b and the anode 10 and between the anion exchange membrane 20b and the cathode 20, and the product produced by irreversibly reacting the cations or anions separated from water in this channel with the anode or cathode may be stably stored. At this time, as described above, by using a NASICON or PA-doped FBI membrane that allows only the movement of sodium (Na⁺) ions and does not pass water through the cation exchange membrane 10b, NaH, which has high reactivity with water, may be maintained stably.

In an embodiment, the cathode 20 may be made of a zinc thin film, and the anode 10 may be made of carbon, for example, a graphite foil. In this case, in order to prevent consumption of the zinc thin film used as the cathode 20, an aqueous solution including zinc particles may be injected into the channel 20a existing between the anion exchange membrane 20b and the cathode 20. In addition, by injecting an organic solvent that is not mixed with water into the channel, the cations and anions separated from the water move to the anode or cathode through the ion exchange membrane, and then perform an irreversible electrochemical reaction with the anode or cathode to generate a new inorganic compound, and thus the generated material may be easily discharged to the outside of the water treatment apparatus together with the organic solvent.

In an embodiment, when passing a brine including sodium chloride (NaCl) while applying a voltage to an apparatus using a zinc thin film as a cathode 20 and a graphite foil as an anode 10, sodium (Na⁺) ions in the brine pass through the NASICON membrane and move toward the graphite foil, and chlorine (Cl⁻) ions pass through the anion exchange membrane and move toward the zinc thin film. At this time, when the applied voltage is adjusted so that the sodium ions and chlorine ions perform irreversible reactions, sodium ions combine with hydrogen ions to produce NaH, and chlorine ions react with zinc to produce ZnCl₂. At this time, the generated NaH has a high reactivity with water, but water may be blocked by the NASICON membrane and thus the NaH may be stably maintained in the membrane. NaH maintained in this way may be converted to sodium borohydride (NaBH₄), a high value-added metal compound through a separate post-treatment. The separate post-treatment process may be performed by reacting trimethylborate (B(OCH₃)₃) and sodium hydride (NaH).

In another embodiment, the cathode 20 and/or the anode 10 may each be formed in a mesh type. In this case, the cathode 20 and/or anode 10 may be prepared by directly adhering to an anion exchange membrane and/or a cation exchange membrane, respectively, and such a water treatment apparatus has an effect of reducing resistance. Herein, channels may be formed by placing gaps between each wall of the housing and opposite surfaces of the anode and/or cathode adhered to the ion exchange membranes, and a solution including an organic solvent, a non-aqueous electrolyte, or a material forming the anode or cathode may be injected to the channels

Herein, ions separated from water may react with the anode and/or cathode in a mesh type, or the material in the channel to generate a new compound, and the new compound, etc. generated as described above may be easily discharged to the outside through the channel.

The water treatment apparatus and the water treatment method may be variously used in the process of separating and purifying ionic substances as well as desalination of seawater, and may be, for example, usefully used in various fields such as water softening process, nitrate nitrogen removal process, recovery process of valuable metals in plating wastewater, heavy metal removal process, and water treatment process.

Hereinafter, the embodiments are illustrated in more detail with reference to examples. However, the examples described below are for illustrative purposes only, and the present invention should not be limited thereto.

### EXAMPLES

### Preparation Example 1. Manufacturing of Water Treatment Apparatus

ASTOM's Neosepta CMX as a cation exchange membrane is attached to one surface of a 250 μm-thick aluminum thin film, and ASTOM's Neosepta AMX as an anion exchange membrane is attached to the other surface, and then, they are cut into 0.5 mm in width and 20 mm in length to manufacture a metal-membrane assembly (MMA), an electrochemical unit.

Next, a graphite foil having a thickness of 370 μm is prepared in the same manner as the above metal-membrane assembly, and two graphite foils cut into 0.5 mm in width and 20 mm in length are prepared, respectively, as a cathode and an anode.

On the other hand, in the lower housing made of transparent polydimethylsiloxane (PDMS) material with three grooves so that the cut metal-membrane assembly and the anode and the cathode are inserted at the same depth at predetermined intervals and can be fixed and arranged in parallel, the prepared anode and cathode are placed in grooves formed at both ends, respectively, the metal-membrane assembly is inserted and fixed in a central groove formed with an equal distance of 1 mm from the anode and cathode, and after covering and fixing the upper housing made of a transparent polydimethylsiloxane (PDMS) material, which is manufactured in the same shape, so that the opposite ends of the anode and the cathode, and the metal-membrane assembly may be inserted and fixed at the same depth, a water treatment apparatus is manufactured by bonding the upper housing and the lower housing through plasma treatment. At this time, in the water treatment apparatus, so that water can pass through between the anode and the metal-membrane assembly and between the cathode and the metal-membrane assembly, an empty space of a certain volume, that is, a channel, is formed between the upper and lower housings, the anode and the metal-membrane assembly, and the cathode and the metal-membrane assembly. In addition, a water inlet for introducing water to be treated into the channels is formed in the upper housing, and a water outlet for discharging water discharged through the channels is formed in the lower housing.

### Preparation Example 2. Manufacturing of Water Treatment Apparatus

A water treatment apparatus is manufactured in the same manner as in Preparation Example 1, but unlike in Preparation Example 1, a water treatment apparatus including three metal-membrane assemblies, which is an electrochemical unit, is manufactured between the anode and the cathode.

That is, graphite foils, which are an anode and a cathode, are inserted into grooves at both ends among the five grooves formed in the lower housing made of transparent polydimethylsiloxane, respectively, three film-metal assemblies disposed at the same distance (about 2 mm interval) are inserted and fixed between the anode and the cathode, the upper housing of the transparent polydimethylsiloxane material manufactured in the same shape is covered thereon and plasma treatment is performed to manufacture a water treatment apparatus.

### Preparation Example 3: Manufacturing of Water Treatment Apparatus

A water treatment apparatus is manufactured in the same manner as in Preparation Example 2, except that a water treatment apparatus is manufactured using a membrane-carbon assembly (MCA) instead of a metal-membrane assembly (MMA) as an electrochemical unit.

Specifically, the membrane-carbon assembly is manufactured by attaching ASTOM's Neosepta CMX grade as a cation exchange membrane on one surface of a 500 μm thick activated carbon fiber, and attaching ASTOM's Neosepta AMX grade as an anion exchange membrane on the other surface.

A water treatment apparatus is manufactured using the manufactured membrane-carbon assembly and the graphite foil manufactured in Preparation Example 1 as an electrochemical unit and an anode and a cathode, respectively, the lower housing and the upper housing made of polydimethylsiloxane in the same manner as in Preparation Example 2.

### Experimental Example 1

In order to measure a performance of the water treatment apparatus manufactured in Preparation Example 2, a mixed solution of 10 mM NaCl aqueous solution and a fluorescent substance (Alexa488, Invitrogen) is added at a flow rate of 20 μL/min through the water inlet formed in the upper housing of the water treatment apparatus. At this time, a voltage of 30 V (Keithley 2461, Keithley Instrument) is applied to the carbon electrode of the apparatus, and the mixed solution is continuously injected into the water inlet using a hydraulic pump (Fusion 200, Revodix), and simultaneously the treated water is allowed to be discharged through the water outlet.

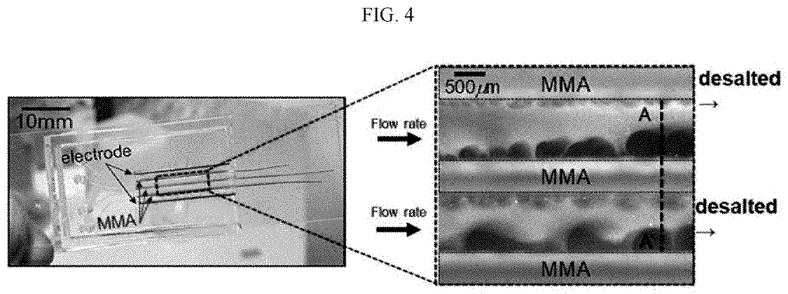

The ion depletion layer around the metal-membrane assembly of the water treatment apparatus is observed through an inverted microscope (IX-73, Olympus) and an EMCCD camera (Image X2, Hamamatsu Photonics K.K.), and the results are shown in FIG. 4.

As a result of checking the desalting performance in real time as shown in the right photograph of FIG. 4, the ion depletion layer appears black around the metal-membrane assembly in the water passing through the water treatment apparatus.

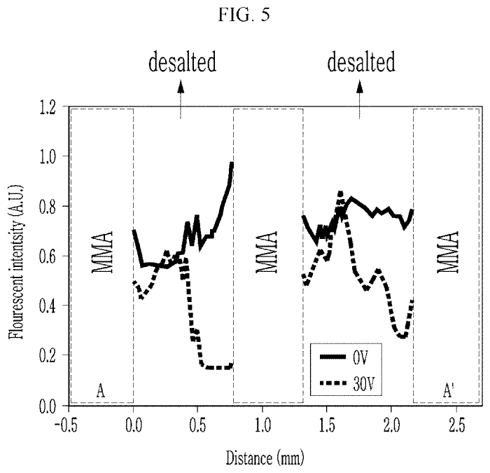

In addition, when the water mixed with the fluorescent dye is moved without applying a voltage to the water treatment apparatus, that is, when the voltage is 0 V and when the water mixed with the fluorescent dye is moved while applying a voltage of 30 V, the result of analyzing the fluorescent dye according to the position between the metal-membrane assembly in the water treatment apparatus using the ImageJ (NIH, USA) program is shown in FIG. 5.

As seen from FIG. 5, when no voltage is applied to the water treatment apparatus, that is, 0 V, a concentration of the fluorescent dye is generally similar or has no particular tendency without being significantly affected by the position of the metal-membrane assembly in the water treatment apparatus whereas when a voltage of 30 V is applied to the water treatment apparatus, the concentration of the fluorescent dye in the vicinity of the metal-membrane assembly is significantly lower than in the center thereof. That is, as the ions bound to the fluorescent dye move toward the metal-membrane assembly due to voltage application, they are separated from the fluorescent dye, and the concentration of the fluorescent dye decreases in the vicinity of the metal-membrane assembly, while the concentration of the fluorescent dye is high in the central portion that is distant from the metal-membrane assembly. That is, by applying a voltage to the water treatment apparatus according to Preparation Example 2, ions in the water move toward the metal-membrane assembly and are desalted.

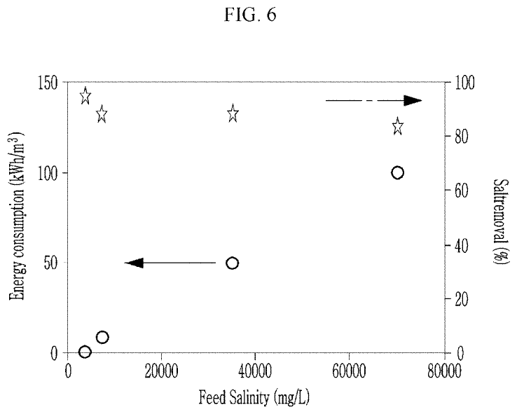

Meanwhile, as shown in Table 1, a NaCl aqueous solution is continuously injected using a hydraulic pump (Fusion 200, Chemyx) into the water treatment apparatus manufactured in Preparation Example 2 while varying the concentration of the NaCl aqueous solution, flow rate, and applied voltage to evaluate salt removal rates and energy consumption rates according to the concentrations of the NaCl aqueous solution, and the results are shown in FIG. 6.

The salt removal rates are calculated by Equation 1, wherein the electrical conductivity of the water outlet of the water treatment apparatus is measured using an electrical conductivity meter (Orionstar A325, Thermo Scientific).

### Equation 1

Salt removal rate (%)=1−(electrical conductivity of water outlet/electrical conductivity of water inlet)×100

TABLE 1

| Concentration of NaCl | Flow rate | Applied | Current |
|---|---|---|---|
| aqueous solution (ppm) | (μL/min) | voltage (V) | (A) |
| 700 | 10 | 10 | 0.00005 |
| 7,000 | 30 | 15 | 0.0011 |
| 35,000 | 30 | 30 | 0.003 |
| 70,000 | 50 | 30 | 0.01 |

Referring to FIG. 6, when a NaCl removal rate from an NaCl aqueous solution by using the water treatment apparatus is evaluated, when a concentration of NaCl is low, the salt removal rate is greater than or equal to 90% even with low energy, and when the concentration of NaCl is very high, the salt removal rate is greater than or equal to 80%. However, the higher the salt concentration, the higher the required energy consumption is.

### Experimental Example 2

In order to measure performance of the water treatment apparatus according to Preparation Example 3, a mixed solution of a 10 mM NaCl aqueous solution and a phosphor material (Alexa488, Invitrogen) is injected at a flow rate of 20 μL/min through the water inlet formed in the upper housing of the water treatment apparatus. Herein, a voltage of 40 V (Keithley 2461, Keithley Instrument, LLC) is applied to the carbon electrode of the apparatus, and a hydraulic pressure pump (Fusion 200, Revodix Inc.) is used to subsequently inject the mixed solution into the water inlet and simultaneously, discharge the treated water through the water outlet.

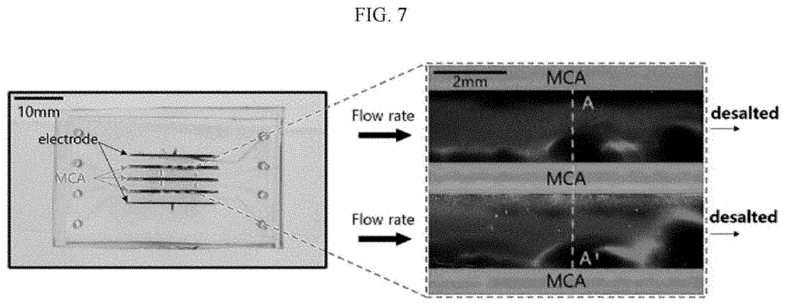

The ion depletion layer around the membrane-carbon assembly of the water treatment apparatus according to Preparation Example 3 is examined through an upright microscope (Axio Zoom V16, Zeiss) and an EMCCD camera (Axiocam 506 ccolor, Zeiss), and the results are shown in FIG. 7.

As shown in a right photograph of FIG. 7, as a result of checking real-time desalination performance, the ion depletion layer around the membrane-carbon assembly in the water passing the water treatment apparatus looks black.

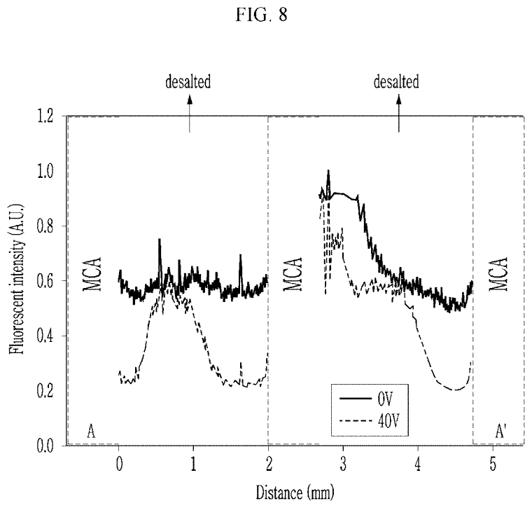

In addition, when water mixed with the fluorescent dye is treated without applying a voltage to the water treatment apparatus, that is, 0 V, and when the water mixed with the fluorescent dye is treated by applying a voltage of 40 V to the water treatment apparatus, a fluorescent dye analysis depending on a position between membrane-carbon assembly in the water treatment apparatus is performed by using an ImageJ (NIH, USA) program, and the results are shown in FIG. 8.

As shown in FIG. 8, when no voltage is applied to the water treatment apparatus, that is, 0 V, a concentration of the fluorescent dye is generally similar or shows no particular trend regardless of a position of the membrane-carbon assembly in the water treatment apparatus, but when the voltage of 40 V is applied to the water treatment apparatus, the concentration of the fluorescent dye around the membrane-carbon assembly is much lower than that of the center portion thereof. In other words, when a voltage is applied, since ions bonded with the fluorescent dye are separated from the fluorescent dye and move towards the membrane-carbon assembly, the fluorescent dye shows a low concentration around the membrane-carbon assembly but still a high concentration in the central portion far from the membrane-carbon assembly. That is, by applying a voltage to the water treatment apparatus according to Preparation Example 3, ions in the water move toward the membrane-carbon assembly and are desalted.

### Preparation Example 4. Manufacturing of Water Treatment Apparatus

A 230 μm-thick zinc thin film and a 370 μm-thick graphite foil are equally cut to have a width of 0.5 mm and a length of 20 mm and respectively used as an anode and a cathode. Herein, the cathode is not limited to the graphite foil but may be replaced with a comprehensive electrode.

Subsequently, a 1 mm-thick NASICON film is used as a cation exchange membrane, and Neosepta AM made by ASTOM Technology Co., Ltd. is cut into a width of 0.5 mm and a length of 20 mm and used as an anion exchange membrane.

Then, a lower housing formed of a transparent polydimethylsiloxane (PDMS) material and having four grooves, into which the cut cation and anion exchange membranes, anode, and cathode are respectively inserted and fixed in parallel at a predetermined distance at the same depth and an upper housing formed of the same transparent polydimethylsiloxane (PDMS) material and having the same shape, so that the other ends of the cation and anion exchange membranes, anode, and cathode may be inserted and fixed thereinto at the same depth, are coated with 30 μL of silane through a chemical vapor deposition (CVD) process.

The cut anode and cathode are fixed and disposed into the grooves formed at both ends of the lower housing, and then, the cut anion exchange membrane is inserted and fixed into a groove at a distance of 1 mm from the cathode, and the cut cation exchange membrane is inserted and fixed into a groove at a distance of 1 mm from the anode. Herein, the cation exchange membrane and the anion exchange membrane are disposed between the anode and the cathode, and are about 1 mm apart each other. Subsequently, the lower housing is covered and fixed with the upper housing formed of the same transparent polydimethylsiloxane (PDMS) material and having the same shape, so that the other ends of the cation and anion exchange membranes, the anode, and the cathode may be fixed thereinto at the same depth and then, bonded together through a plasma treatment to manufacture a water treatment apparatus. Herein, in the water treatment apparatus, empty spaces with a predetermined volume, that is, channels are formed between the upper housing and the lower housing, between the cathode and the anion exchange membrane, between the anion exchange membrane and the cation exchange membrane, and between the cation exchange membrane and the anode so that a zinc chloride aqueous solution may pass between the cathode and the anion exchange membrane, water may pass between the anion exchange membrane and the cation exchange membrane, and a non-aqueous electrolyte may pass between the cation exchange membrane and the anode. Herein, in the channel between the cathode and the anion exchange membrane, any solution not reacting with zinc and having conductivity as well as the zinc chloride aqueous solution may be charged. In addition, a solution inlet for introducing a solution into the channels is formed in the upper housing, and a solution outlet for discharging the solution after passing the channels is formed in the lower housing.

### Preparation Example 5. Manufacturing of Water Treatment Apparatus

A water treatment apparatus is manufactured according to the same method as Preparation Example 4 except that a PA-doped FBI membrane is used instead of the cation exchange membrane.

Specifically, the PA-doped FBI membrane is formed in a method of dipping 50 μm-thick Fumapem AM-40 made by FBI FuMA-Tech GmbH in 0.5 M phosphoric acid for 24 hours. Such a cation exchange membrane can also be manufactured by spraying FBI over an existing cation exchange membrane through a spray, but is not limited to these methods.

### Experimental Example 3

In order to measure performance of the water treatment apparatus according to Preparation Example 4, through three solution inlets on the upper housing of the water treatment apparatus, a 10 mM ZnCl₂ aqueous solution, a mixed solution of a 10 mM NaCl aqueous solution with a phosphor material (Alexa488, Invitrogen), and a mixed solution of a propylene carbonate solution and a 0.1 M NaPF₆ aqueous solution are respectively injected at a flow rate of 10 μL/min. Herein, a voltage of 0 to 100 V (Keithley 2461, Keithley Instrument, LLC) is applied to the carbon electrode of the apparatus, and a hydraulic pressure pump (Fusion 200, Revodix, Inc.) is used to continuously inject the solutions into the solution inlets and simultaneously, discharge treated water through the solution outlet.

In order to prevent consumption of the zinc thin film used as a cathode during the water treatment process, 10 μm-sized zinc particles are dispersed in the 10 mM ZnCl₂ aqueous solution and then, injected at 10 μl/min. Accordingly, the zinc particles are used as a flow electrode to continuously feed zinc, and in addition, at least two bipolar electrodes (BPE) as unit cells may be stacked to accomplish large capacity of the water treatment apparatus.

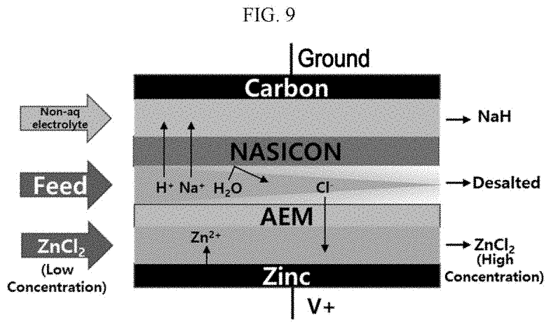

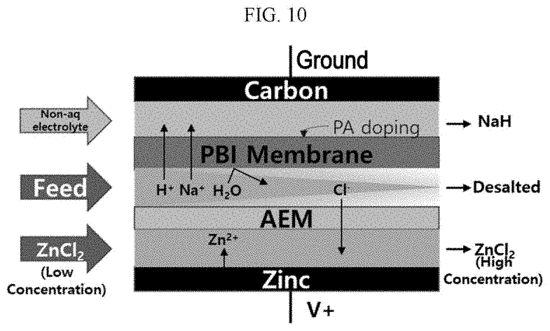

The water treatment apparatuses according to Preparation Examples 4 and 5, a desalting process using the same, and formation and discharge of new compounds produced through this process are schematically shown in each FIGS. 9 and 10.

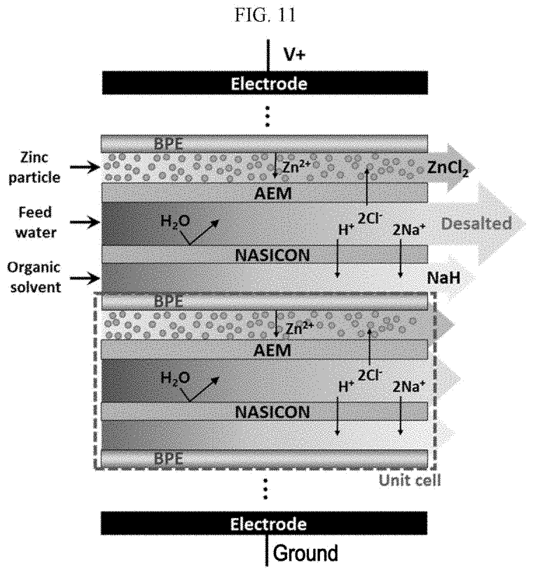

In addition, FIG. 11 schematically shows a water treatment apparatus with a multi-layer structure in which two or more unit cells with bipolar electrodes are stacked, as described above. In FIG. 11, processes of desalting and also, producing and separating new compounds by feeding zinc particles between the bipolar layer (BPE) and the anion exchange membrane (AEM) are shown.

An irreversible electrochemical reaction occurring between the anode and the cathode in the water treatment apparatus according to the experimental example is shown in the following reaction schemes:

Anode: Zn(s)+2Cl⁻→ZnCl₂(aq)+2e⁻

Cathode: 2Na⁺+2e⁻→2NaH(s)

In addition, the ion depletion layer between the cation exchange membrane and the anion exchange membrane of the water treatment apparatus, and sodium hydride (NaH) and zinc chloride (ZnCl₂) or other products in the channels between the anode and the anion exchange membrane and between the cathode and the cation exchange membrane are examined by an inverted microscope (IX-73, Olympus Inc.) and an EMCCD camera (Image X2, Hamamatsu Photonics K.K.).

### Experimental Example 4

A new type compound is synthesized a non-reversible electrochemical reaction of ions separated from water and the metal compound, by pouring an aqueous metal compound solution or a metal slurry between the layer having the bipolarity and ion exchange membranes. Herein, chemical energy released by producing compounds depending on particular compounds may be used to obtain additional benefits of lowering a driving voltage. For example, when a solution including zinc (Zn) slurry is poured into a layer in contact with a portion of the bipolar electrode, which is charged with positive charges not participating in a reaction, Cl— ions flow into the layer in contact with the surface charged with positive charges and then, lose electrons through a reaction with the zinc slurry and are oxidized into zinc chloride (ZnCl₂). Likewise, when a sodium triiodide (NaI₃) aqueous solution is poured into a layer in contact with the portion charged with negative charges, Na⁺ ions flows into the layer, and I₃⁻ ions may receive electrons from the bipolar electrode and thus form sodium iodide (NaI). Herein, iodine metal slurry may be used instead of the sodium triiodide. In addition, this series of reactions has a redox potential of about 1.4 V and plays a role of decreasing the driving voltage.

It is consistent with the examples of using an aluminum bipolar electrode in that it simultaneously removes salt and synthesizes compounds by an applying an electrochemical method, but the synthesized compounds are in an aqueous solution and thus easy to recover. In addition, these compounds (NaI, ZnCl₂) are recovered, which is economical.

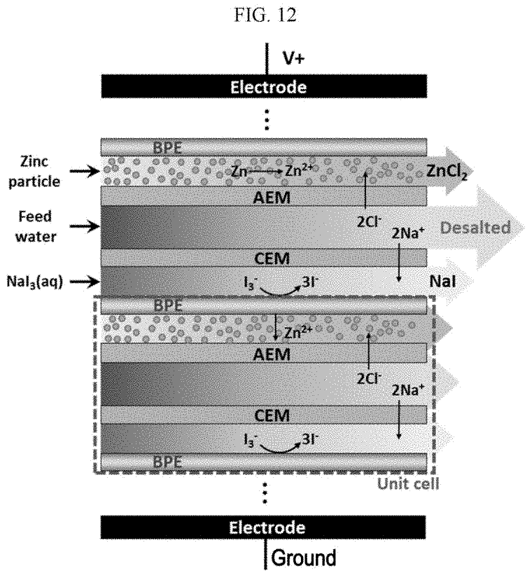

Specifically, a 10 mM ZnCl₂ aqueous solution including 10 μm-sized zinc slurry, a mixed solution of a 10 mM NaCl aqueous solution and a phosphor material (Alexa488, Invitrogen), and a sodium triiodide aqueous solution are respectively injected at a flow rate of 10 μL/min through three solution inlets formed in the upper housing of the water treatment apparatus like in Preparation Example 4. Herein, after applying a voltage of 0 to 6 V (Keithley 2461, Keithley Instrument LLC) to the carbon electrode of the apparatus, the solutions are continuously injected into the solution inlets by using a hydraulic pressure pump (Fusion 200, Revodix Inc.), and simultaneously, the treated water is discharged through the solution outlet. The water treatment apparatus and the water treatment process using the same are schematically shown in FIG. 12.

In addition, the ion depletion layer between the cation exchange membrane and anion exchange membrane of the water treatment apparatus and sodium hydride (NaH) and zinc chloride (ZnCl₂) or other products produced in the channels on each one surface of the anode and the cathode are examined through the inverted microscope (IX-73, Olympus Inc.) and an EMCCD camera (Image X2, Hamamatsu Photonics K.K.).

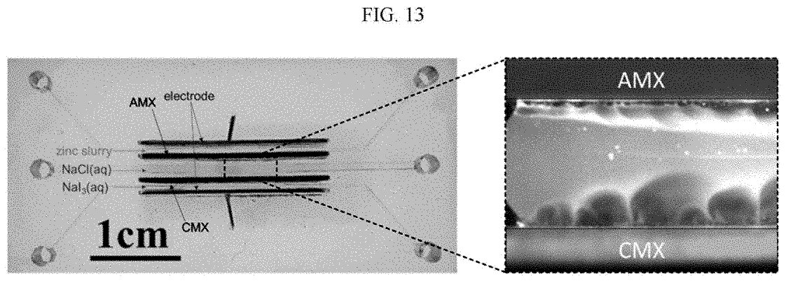

The ion depletion layer around the membrane-carbon assembly of the water treatment apparatus is examined by the upright microscope (Axio Zoom V16, Zeiss) and an EMCCD camera (Axiocam 506 ccolor, Zeiss), and the results are shown in FIG. 13.

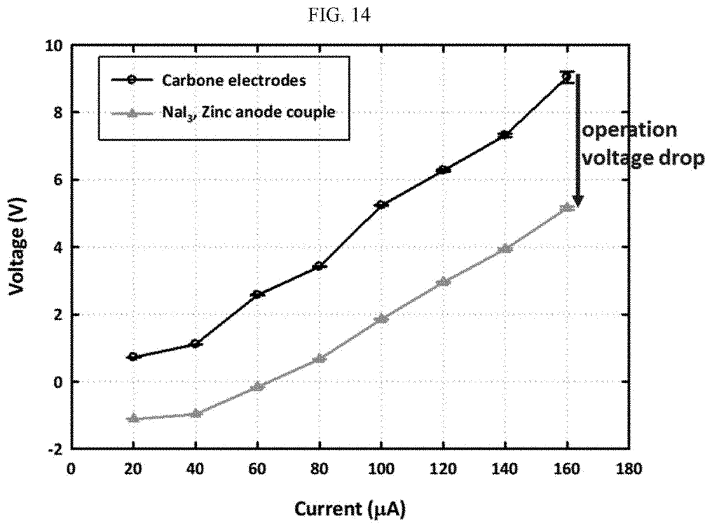

As shown in a right photograph of FIG. 13, as a result of real-time desalting performance, the ion depletion layer around the membrane-carbon assembly appears black in water passing the water treatment apparatus. In addition, when it has the same amount of ion flow (current) as that of a conventional system, the driving voltage is lowered, as shown in a current-voltage graph of FIG. 14.

### Preparation Example 6. Manufacturing of Water Treatment Apparatus

A water treatment apparatus is manufactured similarly to Preparation Example 4. In other words, a 230 μm-thick zinc thin film and a 370 μm-thick graphite foil are respectively cut to have a width of 0.5 mm and a length 20 mm and used as an anode and a cathode. Herein, the cathode is not limited to the graphite foil but may be replaced with a comprehensive electrode.

Subsequently, unlike Preparation Example 4, a cation exchange membrane is prepared by using 1 mm-thick Neosepta CMX made by ASTOM Corp., and an anion exchange membrane is prepared by cutting Neosepta AMX made by ASTOM Corp. into a width of 0.5 mm and a length of 20 mm.

Then, a lower housing made of a transparent polydimethylsiloxane (PDMS) material and having four grooves, into which the cut cation and anion exchange membranes, anode, and cathode are respectively inserted and fixed in parallel at a predetermined distance at the same depth, and an upper housing made of the same transparent polydimethylsiloxane (PDMS) material and having the same shape, into which the other ends of the cut cation and anion exchange membranes, anode, and cathode may be inserted and fixed at the same depth, are coated with 30 μL of silane through a chemical vapor deposition (CVD) process.

The cut anode and cathode are inserted and fixed into the grooves formed at both ends of the lower housing, and then, the cut anion exchange membrane is inserted and fixed into a groove at a distance of 1 mm from the anode, and the cut cation exchange membrane is inserted and fixed into a groove at a distance of 1 mm from the cathode. Herein, the cation exchange membrane and the anion exchange membrane are disposed between the anode and the cathode and are about 1 mm apart each other. The upper housing formed of the transparent polydimethylsiloxane (PDMS) material and having the same shape as the lower housing, into which the opposite ends of the anode, the cathode, the cation exchange membrane, and the anion exchange membrane are inserted and fixed at the same depth, is used to cover the lower housing and then, fixed and bonded together through a plasma treatment to manufacture a water treatment apparatus.

### Preparation Example 7. Manufacturing of Water Treatment Apparatus

A water treatment apparatus is manufactured similarly to Preparation Example 6, but the anode and the cathode are prepared in a mesh form. These mesh type anode and cathode are respectively bonded with the anion exchange membrane and the cation exchange membrane like in Preparation Example 6.

Subsequently, an assembly of the cut cation exchange membrane with the anode and another assembly of the cut anion exchange membrane with the cathode are inserted and fixed into the lower housing formed of the transparent polydimethylsiloxane (PDMS) material and having two grooves at a predetermined distance from both ends and a predetermined distance therebetween, so that the two assemblies may be inserted and fixed thereinto at the same depth and disposed in parallel.

Subsequently, the upper housing formed of the transparent polydimethylsiloxane (PDMS) material and having the same shape as the lower housing, so that the opposite ends of the assembly of the anion exchange membrane and the cathode and the assembly of the cation exchange membrane and the anode may be inserted and fixed thereinto at the same depth, is coated with the lower housing with 30 μL of silane through a chemical vapor deposition (CVD) process.

The opposite ends of the assembly of the cation exchange membrane and the anode and the assembly of the anion exchange membrane and the cathode, which are fixed into the lower housing, are respectively inserted and fixed into the grooves formed in the upper housing. Herein, the two assemblies are disposed to make the cation exchange membrane and the anion exchange membrane face each other, wherein the mesh type anode and cathode are respectively disposed on the rear surfaces of the cation and anion exchange membranes and at a distance of about 1 mm from the end of each polydimethylsiloxane housing. Accordingly, a water treatment apparatus having a channel between the anode and the housing and between the cathode and the housing is manufactured.

### Experimental Example 5

In order to measure performances of the water treatment apparatus according to Preparation Example 6 and Preparation Example 7, through three solution inlets on the upper housing of each water treatment apparatus, a mixed solution of a propylene carbonate solution and 0.1 M NaPF₆ aqueous solution, a mixed solution of 10 mM NaCl aqueous solution and a phosphor material (Alexa488, Invitrogen), and a mixed solution of a propylene carbonate solution and 0.1M NaPF₆ aqueous solution are respectively injected at a flow rate of 10 μL/min.

The propylene carbonate solution may be replaced with any solution in which NaOH, ZnCl₂, or other compounds produced in the water treatment apparatus are not dissolved. The 0.1 M NaPF₆ aqueous solution is used to endow conductivity to the mixed solution, wherein NaPF₆ may be replaced with any other material having no reaction with NaOH, ZnCl₂, or other compounds produced in the water treatment apparatus and no influence on the experiment.

Herein, a voltage of 0 to 100 V (Keithley 2461, Keithley Instrument, LLC) is applied to the carbon electrode of the apparatus, and a hydraulic pressure pump (Fusion 200, Revodix, Inc.) is used to continuously inject the solutions into the solution inlets and simultaneously, discharge treated water through the solution outlet.

In order to prevent consumption of a zinc electrode used as the anode during the water treatment, 10 μm-sized zinc particles are dispersed in a 10 mM ZnCl₂ aqueous solution and then, injected at 10 μl/min. Accordingly, the zinc particles may work as a flow electrode to continuously supply zinc.

Using the same principle as Preparation Examples 6 and 7, at least two bipolar electrodes (BPE) as a unit cell are at least twice stacked to accomplish large capacity of the water treatment apparatus.

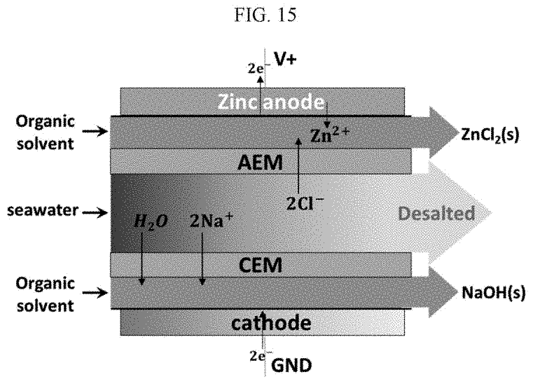

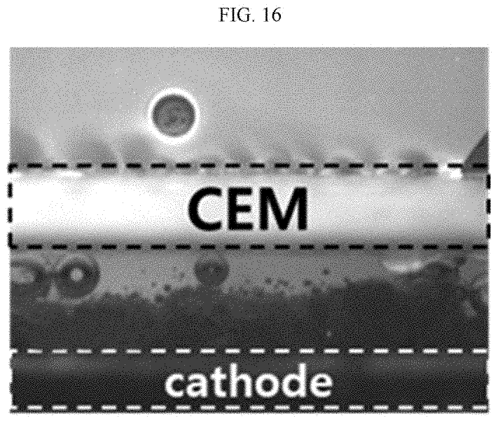

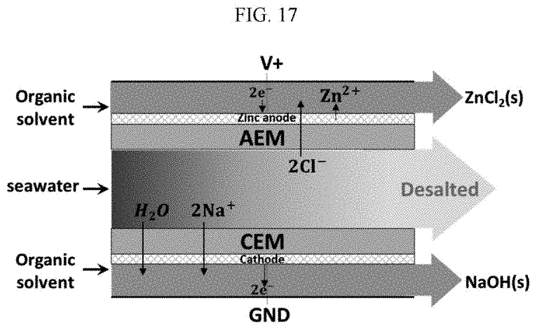

A water treatment method of using the water treatment apparatuses according to Preparation Examples 6 and 7 is schematically shown in FIGS. 15 and 17. In addition, in the water treatment apparatus according to Preparation Example 6, cations introduced through the cation exchange membrane are synthesized into new inorganic compounds in the channel formed between the anode and the cation exchange membrane, which is shown in an electron microscope photograph of FIG. 16. As shown from FIG. 16, when an organic solvent is injected into the channel between the ion exchange membrane and the electrode, the new compounds insoluble in this organic solvent may be immediately produced as a solid. These products may be discharged outside through this channel. This method may easily provide new compounds with high added value without the formation of concentrated water.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

What is claimed is:

1. A water treatment apparatus, comprising
an anode;
a cathode disposed to face the anode at a distance from the anode; and
at least one electrochemical unit disposed at a distance from the anode and the cathode, respectively,
wherein the electrochemical unit comprises a layer having bipolarity when a voltage is applied between the anode and the cathode.

2. The water treatment apparatus of claim 1, wherein the layer having bipolarity comprises an inorganic compound, an organic compound, a mixture of an inorganic compound and an organic compound, a composite of an inorganic compound and an organic compound, or a combination thereof.

3. The water treatment apparatus of claim 2, wherein the inorganic compound comprises a metal.

4. The water treatment apparatus of claim 3, wherein the metal comprises a transition metal, a post-transition metal, a metalloid, or a combination thereof.

5. The water treatment apparatus of claim 2, wherein the organic compound comprises carbon, a conductive polymer, or a combination thereof.

6. The water treatment apparatus of claim 1, wherein the at least one electrochemical unit further comprises a cation exchange membrane and/or an anion exchange membrane respectively disposed on one surface or both surfaces of the layer having bipolarity facing the cathode and/or anode.

7. The water treatment apparatus of claim 6, wherein the cation exchange membrane is an organic material membrane comprising polystyrene, polyimide, polyester, polyether, polyethylene, polytetrafluoroethylene, polymethylammonium chloride, polyglycidyl methacrylate, or a combination thereof, a NASICON ceramic film, or a phosphoric acid-doped FBI film (PA doped polybenzimidazole membrane).

8. The water treatment apparatus of claim 1, wherein the layer having bipolarity has a plate type, a mesh type, a compressed type of particles, a solution type comprising particles, or a combination thereof.

9. The water treatment apparatus of claim 1, wherein the water treatment apparatus comprises two or more electrochemical units between the anode and the cathode, wherein the two or more electrochemical units are disposed to have a space therebetween.

10. The water treatment apparatus of claim 1, which further comprises a housing that accommodates the anode, the cathode, and the at least one electrochemical unit therein, and further comprises a water inlet for feeding water to a space between the anode and the at least one electrochemical unit and between the cathode and the at least one electrochemical unit, and a water outlet for discharging water discharged from the space.

11. A water treatment method, comprising
while applying a voltage between anode and a cathode disposed in a water treatment apparatus that further comprises an electrochemical unit disposed between the anode and the cathode, the electrochemical unit including a layer having bipolarity when a voltage is applied between the anode and the cathode,
feeding water comprising a salt to a space between the anode and the electrochemical unit and to a space between the cathode and the electrochemical unit, such that a cation and an anion are separated from the salt and move to the anode, cathode, and the layer having bipolarity in the electrochemical unit, and
discharging desalted water.

12. The water treatment method of claim 11, wherein at least one of both surfaces of the layer having bipolarity, and/or at least one of the surfaces facing the layer having bipolarity of the anode and the cathode further comprises a cation exchange membrane or an anion exchange membrane disposed on the surface, or a combination thereof.

13. The water treatment method of claim 11, wherein the voltage applied between the anode and the cathode is about 0.1 V to about 1,000 V.

14. The water treatment method of claim 11, wherein the cation and anion moved to the anode, the cathode, and the layer having bipolarity of the electrochemical unit are adsorbed to at least one of the anode, the cathode, and/or the layer having bipolarity of the electrochemical unit.

15. The water treatment method of claim 11, wherein the cation and the anion moved to the anode, the cathode, and/or the layer having bipolarity of the electrochemical unit perform an irreversible electrochemical reaction with at least one of the anode, the cathode, and/or the layer having bipolarity of the electrochemical unit.

16. The water treatment method of claim 11, wherein the water treatment method does not produce brine.

17. The water treatment method of claim 11, wherein the layer having bipolarity comprises a solution comprising particles or is a mesh type.

18. The water treatment method of claim 17, wherein the solution comprising particles is a solution comprising zinc particles.

19. A water treatment method comprising
while applying a voltage between an anode and a cathode disposed to face the anode and have a space therefrom,
feeding water comprising a salt to the space, such that a cation and an anion are separated from the salt in the water and move to the anode and cathode, respectively, wherein the moved cation and/or anion performs an irreversible electrochemical reaction with the anode and/or cathode, respectively, and
discharging desalted water.

20. The water treatment method of claim 19, wherein an anion exchange membrane is disposed on one surface of the cathode, and a cation exchange membrane is disposed on one surface of the anode.
